(19) United States
(12) Patent Application Publication
(10) Pub. No.: US 2020/0134683 A1
(43) Pub. Date: Apr. 30, 2020

(54) DATABASE SYSTEMS AND METHODS FOR DYNAMIC QUOTE GUIDANCE

(71) Applicant: salesforce.com, inc., San Francisco, CA (US)

(72) Inventors: Daniel Boren, San Francisco, CA (US); Shrestha Basu Mallick, San Francisco, CA (US); Glenn Dearing, Menlo Park, CA (US); Robert DeSisto, Westford, MA (US); Arun Kumar Jagota, Sunnyvale, CA (US)

(73) Assignee: salesforce.com, inc., San Francisco, CA (US)

(21) Appl. No.: 16/177,080

(22) Filed: Oct. 31, 2018

(51) Int. Cl. G06Q 30/06; G06F 17/30; G06Q 30/02

(52) U.S. Cl. CPC G06Q 30/0611; G06Q 30/0283; G06F 17/30994; G06F 17/30002

(57) ABSTRACT

Computing systems, database systems, and related methods are provided for guiding a user defining a quote for a product. One method involves a server obtaining one or more values for one or more attributes of a quote from a client device coupled to the server over a network, obtaining an expected pricing model for the quote from a database, determining expected pricing information for the quote based on the one or more values for the one or more attributes using the model, and providing a graphical indication of the expected pricing information on the client device. The expected pricing model is determined based on historical relationships between quote attributes and price for previously-closed quotes.

### TECHNICAL FIELD

Embodiments of the subject matter described herein relate generally to database systems, and more particularly, to methods and systems that support dynamic graphical user interfaces responsive to changes to attributes or parameters of a quote created using a database system.

### BACKGROUND

Modern software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” or “on-demand” by an infrastructure provider. The infrastructure provider typically abstracts the underlying hardware and other resources used to deliver a customer-developed application so that the customer no longer needs to operate and support dedicated server hardware. The cloud computing model can often provide substantial cost savings to the customer over the life of the application because the customer no longer needs to provide dedicated network infrastructure, electrical and temperature controls, physical security and other logistics in support of dedicated server hardware.

Customer relationship management (CRM) systems have been developed to allow individuals to manage contacts, customers, sales, opportunities, and the like. Discounting is a common practice engaged in by salespersons to match net price with customer value and/or situation. However, discounts may often be priced based on anecdotal evidence (e.g., a salesperson's personal knowledge of prior deals), a one-size fits all approach, or an otherwise incomplete set of factors that leads to suboptimal pricing, which may undesirably impact a salesperson's performance and/or the company's bottom line. From a customer perspective, mis-priced deal could set the wrong value expectations and later lead to customer dissatisfaction or churn. Accordingly, it is desirable to provide database systems and methods that leverage available data to improve guidance for deal pricing.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary computing system;

FIG. 2 is a flow diagram of an exemplary quote guidance process suitable for implementation in the computing system of FIG. 1 in accordance with one or more embodiments;

FIGS. 3-7 depict exemplary graphical user interface (GUI) displays illustrating the quote guidance process of FIG. 2 in accordance with one or more exemplary embodiments;

FIGS. 8-10 depict exemplary dashboard GUI displays suitable for presentation in the computing system of FIG. 1 in connection with one or more exemplary embodiments of the quote guidance process of FIG. 2;

FIGS. 11-12 depict exemplary GUI displays suitable for presentation in the computing system of FIG. 1 in connection with developing an expected pricing model for use with the quote guidance process of FIG. 2 in one or more exemplary embodiments; and

FIG. 13 is a block diagram of an exemplary multi-tenant system suitable for use with the computing system of FIG. 1 in accordance with one or more embodiments.

### DETAILED DESCRIPTION

Embodiments of the subject matter described herein generally relate to database systems and methods for dynamically updating graphical user interface (GUI) displays based on user-defined attributes for a quote. As described in greater detail below, artificial intelligence is utilized to identify price-correlative factors based on historical quotes or deals and generate a corresponding pricing model, which, in turn may be applied to the attribute values defined for a current quote of interest to determine expected pricing information for the current quote (e.g., an expected discount price, an expected discount amount or percentage, a qualitative assessment of the quote, and the like). A salesperson may utilize the expected pricing information to reliably identify or determine which attributes of the quote may be adjusted to achieve a desired outcome, with the expected pricing information being dynamically updated in response to user-initiated changes to the values for different attributes of the quote. To this end, in some embodiments, the GUI display may identify or otherwise indicate which attributes of the quote correspond to the variables or factors in the pricing model that are most influential or most strongly correlated to the expected pricing outcome.

Additionally, reactive guidance may be provided to the user to help the user identify his or her qualitative pricing performance with respect to the current quote. For example, the quote may be qualitatively assessed or scored with respect to historical quotes or deals maintained in the database system, with corresponding indicia provided to the user to identify the qualitative performance associated with the current quote. As one example, historical data for similar quotes may be utilized to derive a normal discount similar quotes (e.g., the 50^{th} percentile) and a target discount (e.g., the 85^{th} percentile). If the user proposes a discount percentage that is less than the targeted discount percentage, reactive guidance may be provided using a visually distinguishable characteristic (e.g., a green color) or other symbology that indicates an above target qualitative state for the quote, while a proposed discount percentage between the target and normal discount would result in reactive guidance indicating an average qualitative state, and a proposed discount percentage greater than the normal discount would result in reactive guidance indicating a below average qualitative state. Thus, a user may identify how overpriced or underpriced the proposed quote may be. Various different approval, notification, or other workflow rules or rule-based logic may also be performed on the current quote based on the qualitative scoring of the quote. In one or more exemplary embodiments, dashboard GUI displays depicting the qualitative or quantitative quote performance multiple quotes are also provided to facilitate retrospective analysis of the historical pricing performance for individual users, groups, deal teams, etc.

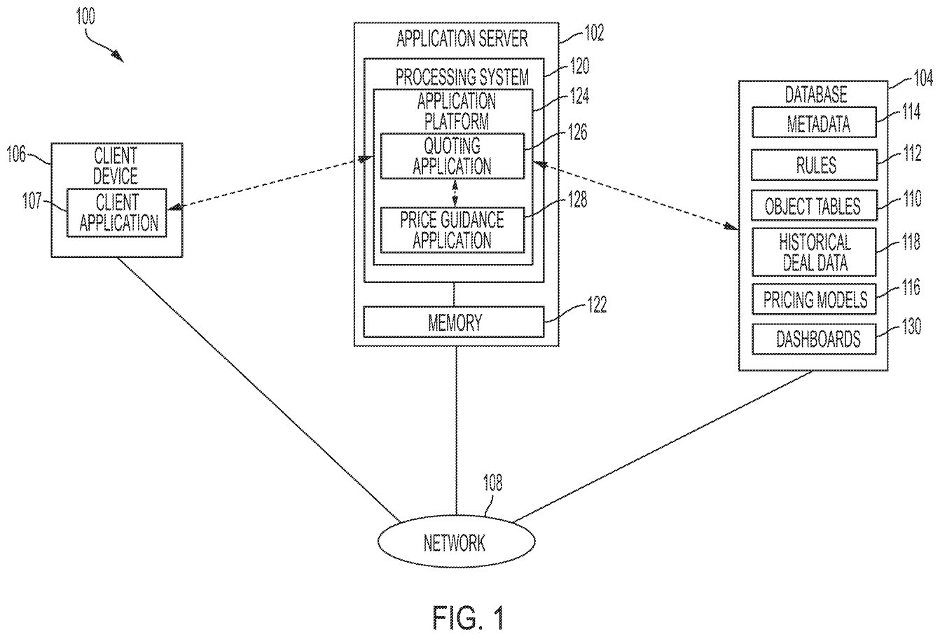

FIG. 1 depicts an exemplary embodiment of a computing system 100 capable of providing quote guidance to a user of a client device 106 by an instance of an application provided by a server 102 utilizing one or more components maintained in a database 104. In the illustrated embodiment, the server 102 is communicatively coupled to the database 104 and the client device 106 via a communications network 108. The communications network 108 may be realized as any sort or combination of wired and/or wireless computer network, a cellular network, a mobile broadband network, a radio network, the Internet, or the like. It should be noted that FIG. 1 is a simplified representation of a computing system 100 for purposes of explanation and is not intended to be limiting. For example, in practice, multiple instances of client devices 106 communicating on the network 108 may be present, with any number of instances of applications being provided by the server 102 to various instances of client devices 106. Additionally, practical implementations may include multiple instances of the server 102 and/or the database 104, which, in turn may reside behind or rely on one or more load balancers to manage resource utilization, as will be appreciated in the art.

The server 102 generally represents a computing device, computing system or another combination of processing logic, circuitry, hardware, and/or other components configured to support the conversational interaction processes, tasks, operations, and/or functions described herein. In this regard, the server 102 includes a processing system 120, which may be implemented using any suitable processing system and/or device, such as, for example, one or more processors, central processing units (CPUs), controllers, microprocessors, microcontrollers, processing cores and/or other hardware computing resources configured to support the operation of the processing system 120 described herein. The processing system 120 may include or otherwise access a data storage element 122 (or memory) capable of storing programming instructions for execution by the processing system 120, that, when read and executed, cause processing system 120 to support the processes described herein. Depending on the embodiment, the memory 122 may be realized as a random-access memory (RAM), read only memory (ROM), flash memory, magnetic or optical mass storage, or any other suitable non-transitory short or long-term data storage or other computer-readable media, and/or any suitable combination thereof. In one or more embodiments, the programming instructions cause the processing system 120 to create, generate, or otherwise facilitate the application platform 124 that generates or otherwise provides instances of a virtual application at run-time (or “on-demand”) based at least in part upon code and other data that is stored or otherwise maintained by the database 104. Accordingly, for purposes of explanation but without limitation, the server 102 may alternatively be referred to herein as an application server 102.

In exemplary embodiments, the programming instructions also cause the processing system 120 to create, generate, or otherwise facilitate an application 126 that supports that allows users to create or otherwise define quotes and modify attributes of quotes in response to automated guidance provided by a price guidance application 128, as described in greater detail below. Depending on the embodiment, the quoting application 126 and/or the price guidance application 128 can be integrated with or otherwise incorporated as part of a virtual application, or be realized as a separate or standalone process, application programming interface (API), software agent, or the like that is capable of interacting with the client device 106 independent of the virtual application to perform actions with respect to the database 104.

The client device 106 generally represents an electronic device coupled to the network 108 that may be utilized by a user to access the application platform 124 on the application server 102 to retrieve data from the database 104 via the network 108. In practice, the client device 106 can be realized as any sort of personal computer, mobile telephone, tablet or other network-enabled electronic device. In exemplary embodiments, the client device 106 includes a display device, such as a monitor, screen, or another conventional electronic display, capable of graphically presenting data and/or information provided by the application platform 124 along with a user input device, such as a touchscreen, a touch panel, a mouse, a joystick, a directional pad, a motion sensor, or the like, capable of receiving input from the user of the client device 106. The illustrated client device 106 executes or otherwise supports a client application 107 that communicates with the application platform 124 on the server 102 using a networking protocol. In some embodiments, the client application 107 is realized as a web browser or similar local client application executed by the client device 106 that contacts the application server 102 and/or application platform 124 using a networking protocol, such as the hypertext transport protocol (HTTP) or the like, to access or otherwise initiate an instance of a virtual application presented on the client device 106.

In exemplary embodiments, the database 104 stores or otherwise maintains data for integration with or invocation by a virtual application in objects organized in object tables 110. In this regard, the database 104 includes a plurality of different object tables 110 configured to store or otherwise maintain alphanumeric values, metadata, or other descriptive information that define a particular instance of a respective type of object associated with a respective object table 110. For example, the virtual application may support a number of different types of objects that may be incorporated into or otherwise depicted or manipulated by the virtual application, with each different type of object having a corresponding object table 110 that includes columns or fields corresponding to the different parameters or criteria that define a particular instance of that object.

In exemplary embodiments described herein, the database 104 stores or otherwise maintains application objects (e.g., an application object type) where the application object table 110 includes columns or fields corresponding to the different parameters or criteria that define a particular application capable of being generated or otherwise provided by the application platform 124 on a client device 106. In this regard, the database 104 may also store or maintain graphical user interface (GUI) objects that may be associated with or referenced by a particular application object and include columns or fields that define the layout, sequencing, and other characteristics of GUI displays to be presented by the application platform 124 on a client device 106 in conjunction with that application. Additionally, the database 104 stores or otherwise maintains additional database objects for association and/or integration with the application, which may include custom objects and/or standard objects, such as, for example, opportunity objects, quote objects, product objects, and the like, as described in greater detail below.

In exemplary embodiments, the database 104 also includes or otherwise maintains one or more tables 112 that include one or more rules or criteria associated with respective types of database object types that may be applied to entries in the various database object tables 110. For example, a validation rule provides validation criteria for one or more fields (or columns) of a particular database object type, such as, minimum and/or maximum values for a particular field, a range of allowable values for the particular field, a set of allowable values for a particular field, or the like. Additionally, the validation rule may provide a default value to be assigned to a field (or column) of a particular database object table 110 when the value for that field of a particular record or entry in that database object table 110 does not satisfy the validation criteria for that field. In some embodiments, the validation rules associated with a particular database object type may identify or otherwise indicate required fields for that particular object. Exemplary embodiments described herein also utilize notification rules, approval rules, or other rules that provide criteria or logic for performing different automated actions based on the value(s) for particular field(s) or column(s) of a given object or related objects.

Additionally, the database 104 stores or otherwise maintains metadata 114, which may be utilized to perform data manipulation and/or formatting. For example, the metadata 114 may include or define describe any number of workflows, process flows, formulas, business logic, structure and other database components or constructs that may be associated with a particular application database object. In this regard, in some embodiments, the metadata 114 may associated with a particular type of application or other database component may identify or otherwise indicate other database objects may be required for supporting the particular workflows, process flows, formulas, business logic, or other aspects of the logical structure of that application.

In the illustrated embodiment, the database 104 stores or maintains pricing models 116 that may be utilized to determine expected pricing information, as described in greater detail below. For example, a price guidance application 128 on a server 102 may utilize artificial intelligence or machine learning techniques to determine which combination of attributes or variables of historical quotes for closed deals pertaining to a particular product (or combination of products) associated with a particular user, organization, or tenant are correlated to or predictive of the resulting price associated with those deals, and then determine a corresponding equation, function, or model for calculating the expected price for that particular product (or combination of products) based on that set of input variables. Thus, the pricing model is capable of characterizing or mapping a particular combination of attributes of a quote for a product (or combination of products) to an expected pricing that is consistent with historical quotes with similar attributes for previously closed deals for that product (or combination of products). It should be noted that the subset of input variables that are predictive of or correlative for a particular product or product combination may vary across different users, organizations or tenants, and/or the relative weightings applied to the respective attributes or variables of a respective predictive subset may also vary across different users, organizations or tenants based on differing correlations between a particular quote attribute and the historical quote data for that particular user, organization or tenant. It should be noted that any number of different artificial intelligence or machine learning techniques may be utilized to determine what input quote attributes are predictive of pricing, and the subject matter described herein is not limited to any particular modeling technique.

In the illustrated embodiment, the database 104 also stores or maintains historical deal data 118 that includes statistics or other metrics characterizing previously closed quotes or deals, such as, for example, average price per unit, median price per unit, average quantity, median quantity, average term, median term, and/or the like. As described in greater detail below, the historical deal data 118 may be utilized by the price guidance application 128 to qualitatively analyze quotes or provide other qualitative guidance based on the relationship between a current quote and the historical deal data 118. Similar to the pricing models 116, the historical deal data 118 may be calculated or otherwise determined by a price guidance application 128 on a server 102 analyzing the historical quotes for closed deals pertaining to a particular product (or combination of products) associated with a particular user, organization, or tenant.

In exemplary embodiments, the database 104 also includes a dashboard table 130 that maintains one or more dashboard GUI displays and one or more report visualizations associated therewith for graphically depicting the qualitative or quantitative performance associated with closed quotes or deals, or individual users, organizations, or tenants. For example, one or more bar charts, pie charts, gauge charts, tabular charts, and/or the like may be provided on a dashboard GUI display to depict the qualitative distribution of the closed quotes associated with a particular user or set of users, along with other graphical indicia or depictions of quantitative metrics associated with those closed quotes. In this regard, a sales manager may utilize the dashboard GUI display(s) to review the pricing performance of individual salespersons or a group of salespersons, as described in greater detail below. A deal review team (or deal desk) may use a dashboard to compare a given quote with previously approved deals with similar attribute values, while a pricing strategy team may use a dashboard with similar data to estimate model impact and guidance and/or pricing improvement opportunities.

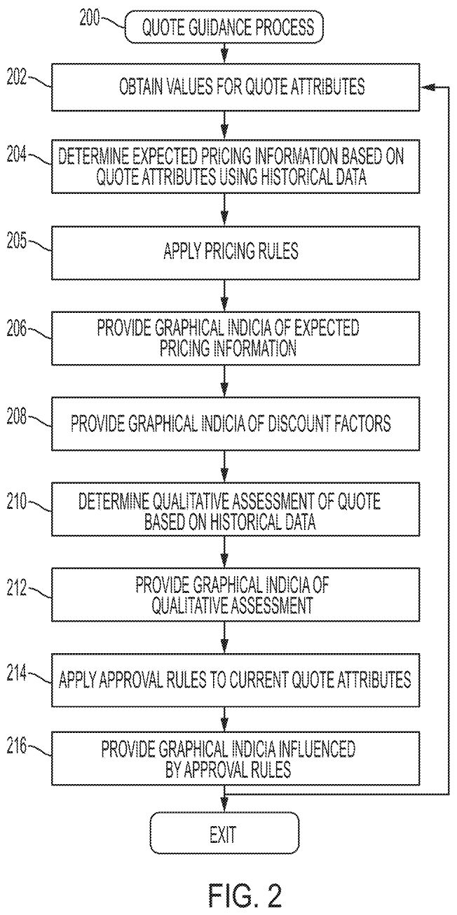

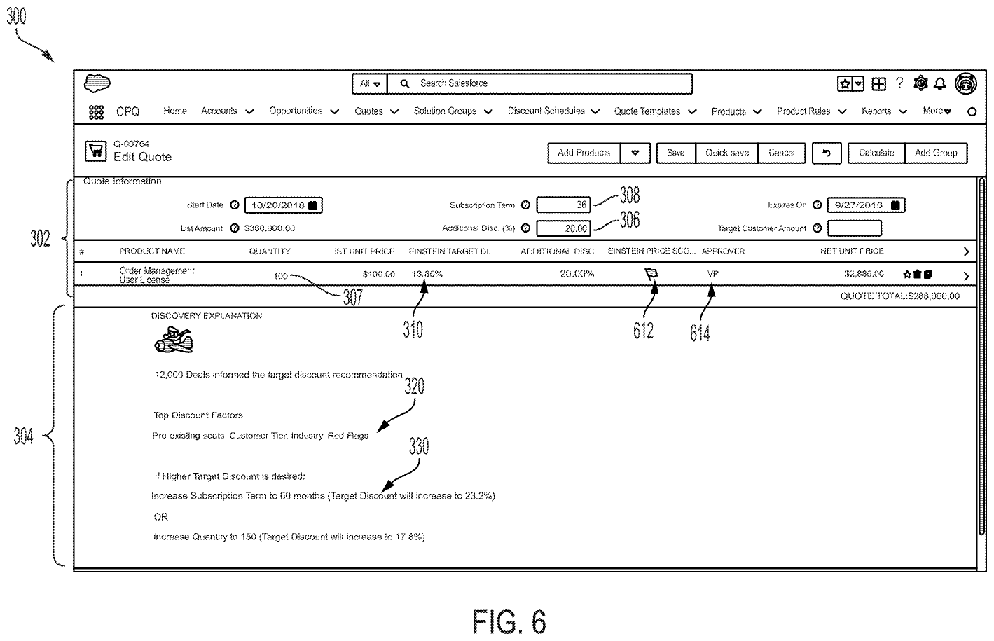

FIG. 2 depicts an exemplary embodiment of a quote guidance process 200 suitable for implementation in a computing system such as computing system 100 to dynamically provide quote guidance. For illustrative purposes, the following description may refer to elements mentioned above in connection with FIG. 1. In this regard, while portions of the quote guidance process 200 may be performed by different elements of the computing system 100, for purposes of explanation, the subject matter is described herein in the context of the quote guidance process 200 being primarily performed by the application platform 124, the quoting application 126 and/or the price guidance application 128 that are implemented or executed by the processing system 120 at the server 102. It should be appreciated that the quote guidance process 200 may include any number of additional or alternative tasks, the tasks need not be performed in the illustrated order and/or the tasks may be performed concurrently, and/or the quote guidance process 200 may be incorporated into a more comprehensive procedure or process having additional functionality not described in detail herein. Moreover, one or more of the tasks shown and described in the context of FIG. 6 could be omitted from a practical embodiment of the quote guidance process 200 as long as the intended overall functionality remains intact.

Referring to FIG. 2 with continued reference to FIG. 1, the quote guidance process 200 initializes or otherwise begins receiving or otherwise obtaining values for different attributes of a quote (task 202). For example, a GUI display associated with the quoting application 126 presented at the client device 106 may be utilized by a user of the client device 106 to input or otherwise provide values for different attributes that define a new quote to be created, such as identification of the product(s) to be associated with the quote, the respective quantity of product(s) for the quote, a term associated with the quote, a customer or client associated with the quote, and the like. In some embodiments, initial values for one or more of the quote attributes may be determined based on historical data maintained in the database 104 or other default values that may be defined for the product(s) by the user (or the user's organization or tenant). For example, one or more database objects 110 associated with the customer or client associated with the quote may be utilized to obtain a geographic region, a tier, an industry sector, and/or other attributes associated with that particular customer or client.

After obtaining initial quote attribute values, the quote guidance process 200 automatically calculates or otherwise determines expected pricing information for the quote based on the initial quote attribute values using a model derived based on relationships between quote attribute values and pricing from historical data associated with previously closed or completed quotes (task 204). In this regard, in exemplary embodiments, the quoting application 126 provides the quote attribute values to the price guidance application 128 which accesses the database 104 to obtain the appropriate pricing model 116 associated with the particular product(s) associated with the quote. The quote attribute values are then input or otherwise provided to the equation or formula defined by the pricing model 116 to calculate expected pricing information for the current quote attribute values. For example, in one or more embodiments, the pricing model 116 automatically calculates an expected discount percentage of the default or standard pricing for the product(s) based on the current quote attribute values, resulting in an expected discount percentage that reflects historical correlations or relationships between those quote attributes and historical pricing for the relevant product(s). That said, in other embodiments, the pricing model 116 may be configured to calculate a per unit price, or another suitable pricing metric or statistic.

As described above, in exemplary embodiments, the expected pricing model calculates an expected discount percentage based on the subset of quote attributes that are most correlative to or predictive of price based on historical deal data for the product of interest, with different weightings assigned to different quote attributes. For example, machine learning or other artificial intelligence may be applied to historical deal data for the user's organization or tenant to derive a formula or equation for an expected discount percentage as a function of the quote quantity and the customer tier based on a statistically significant relationship for those attributes with respect to the historical discount percentage. Using the respective weightings assigned to those attributes by the expected pricing model, the price guidance application 128 may calculate an expected discount percentage for the current quote based on the user-defined quantity associated with the quote and the tier associated with the current customer or client. In some embodiments, the price guidance application 128 may attempt to determine an expected pricing model in the absence of an existing pricing model 116 associated with the product(s) for the current quote.

In one or more embodiments, the quote guidance process 200 applies one or more pricing rules to the current quote (task 205). In this regard, the pricing rules provide rule-based logic that may be utilized to influence or override the model-predicted expected pricing, for example, by imposing limits or other constraints on the model output. Pricing rules may also be applied to the attribute values for the current quote to facilitate providing guidance by determining expected pricing information when the historical data for the current product(s) of interest is otherwise insufficient to create an expected pricing model with a desired level of accuracy or reliability. For example, different pricing rules associated with one or more products may be defined by a user (or a user's organization or tenant) and stored in the database 104 in association with the applicable product(s). In the absence of an expected pricing model for the current product(s) of interest, the price guidance application 128 may query the database 104 for any pricing rules associated with the current product(s) of interest and then apply the retrieved pricing rules to the current attribute values.

In one or more exemplary embodiments, the pricing rules may define different discounts to be applied based on different threshold values for different attributes of the quote, such as, for example, minimum or maximum discount percentages for a given quantity of product, amounts to increase or decrease the discount by when the quantity exceeds or fails to exceed a particular threshold, minimum or maximum discount percentages for a given term associated with the quote, amounts to increase or decrease the discount by when the term exceeds or fails to exceed a particular threshold, and the like. Percentiles or other statistical measures may also be identified based on historical data and incorporated into the pricing rules to guide the user towards a price consistent with historical pricing with a desired amount of uplift. Additionally, the pricing rules may incorporate other factors, such as, the identity of the customer or client, the tier associated with the customer or client, the historical data associated with that particular customer or client, and the like.

It should be noted that in some embodiments, the price guidance application 128 may obtain pricing rules from the database 104 and apply the pricing rules concurrently or in concert with the expected pricing model to override or otherwise constrain the expected pricing information output by the pricing model to a rule-based maximum or minimum pricing. For example, the pricing rules may set a maximum discount percentage not to be exceeded, such as, a maximum discount percentage for the current quantity of product independent of the deal term or other factors, a maximum discount percentage for the current deal term independent of quantity or other factors, a maximum discount percentage for the current customer tier or geographic region independent of other factors, etc.

Still referring to FIG. 2, in exemplary embodiments, the quote guidance process 200 generates, displays, or otherwise provides graphical indicia of the expected pricing information to the user along with graphical indicia of the attributes of the quote that are most influential to the expected pricing information (tasks 206, 208). For example, as described in greater detail below, the price guidance application 128 may provide the expected discount percentage, expected unit price, or other expected pricing information to the quoting application 126 along with identification of the quote attributes that are most heavily weighted or correlated with the expected pricing information based on the obtained pricing model 116 that was utilized by the price guidance application 128. In some embodiments, the expected discount percentage may be scaled downward (or the expected unit price upward) by some uplift percentage (which may be configurable by the user or a supervisor) prior to presentation. The quoting application 126 may then display, within the client application 107 at the client device 106, a graphical representation of the expected pricing information along with an ordered list of the quote attributes that were most influential on the expected pricing information. Additionally, as described in greater detail below, in one or more embodiments, the price guidance application 128 may calculate or otherwise determine different expected pricing information for different quote modifications and provide that information to the quoting application 126 for presentation in concert with the influential quote attributes. For example, a scenario analysis may be performed using the obtained pricing model 116 with different combinations of values of the quote attributes to identify which quote modifications are most influential on the expected pricing. In this regard, the different expected pricing information for different quote modifications may be utilized by the user as a guide for how to modify the current quote to achieve a desired pricing outcome in concert with the knowledge of what quote attributes are most influential on the expected pricing.

In exemplary embodiments, the quote guidance process 200 also calculates or otherwise determines a qualitative assessment of the current quote based on the historical deal data and provides graphical indicia of the qualitative assessment of the current quote (tasks 210, 212). In this regard, the current quote may be scored or otherwise compared to the historical deal data 118 and the various historical deal metrics to assign a qualitative state to the current quote that may be utilized to provide reactive guidance as the user modified aspects of the quote. For example, the current quote may be classified into one of multiple different qualitative categories based on one or more current quote attributes.

As described in greater detail below, in one or more exemplary embodiments, based on the current discount percentage associated with the current quote, the current quote is qualitative classified as being above average, average, or below average based on the relationship between the current discount percentage and historical discount percentages associated with the user or the user's associated organization, group, or tenant. For example, the current quote may be classified as above average if the current discount percentage less than both the average and median discount percentage for the current product(s), as average if the current discount percentage less than only one of the average and median discount percentage for the current product(s), or as below average if the current discount percentage greater than both the average and median discount percentage for the current product(s). As another example, current quote may be classified based on different percentiles relative to the historical deal distribution. In this regard, it should be noted that any number of different criteria may be utilized to assign a qualitative state or score to a quote, and the subject matter is not limited to any particular qualitative assessment scheme. In this regard, in practical embodiments, a user may define the qualitative states or criteria to be applied to quotes associated with a particular product in a manner that is specific to a particular user, group, organization, and/or tenant.

Still referring to FIG. 2, in exemplary embodiments, the quote guidance process 200 applies one or more approval rules to the current quote and generates or otherwise provides one or more graphical indicia that are influenced by the approval rules (tasks 214, 216). For example, as described in greater detail below, in one or more embodiments, different approval or notification rules may be established that require different supervisory users to approve or be notified of a quote prior to closing the deal based on the qualitative state of the quote or other quote attributes (e.g., the discount percentage, the quantity, the term, the customer tier, and/or the like). When one or more of the current quote attribute values satisfies an approval or notification rule, the quoting application 126 may generate or otherwise provide a corresponding notification or other graphical indicia within the client application 107 at the client device 106. Other validation rules, workflow rules, and the like may also be established and applied to the quote to perform different actions based on the proposed pricing.

In exemplary embodiments, the loop defined by tasks 202, 204, 206, 208, 210, 212, 214 and 216 repeats to dynamically update the guidance provided to the user in response to changes to values for different attributes of the quotes. In this regard, based on the expected pricing information and discount-influencing factors presented by the quoting application 126, the user may modify the value(s) for one or more attributes of the quote to achieve a desired pricing that is more consistent with the expected pricing based on historical deals. For example, a salesperson negotiating with a customer or client seeking a particular unit price or discounting relative to the list price may identify potential ways to adjust or tailor the quote to satisfy the client's objectives and match price with the client's value or situation.

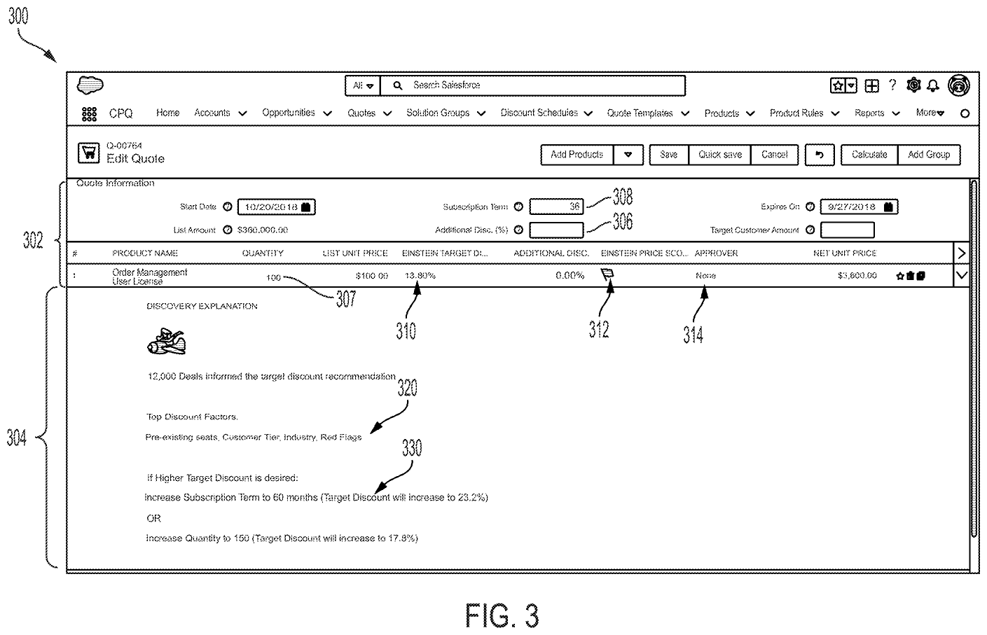

FIGS. 3-7 depict an exemplary sequence of GUI displays suitable for presentation by the quoting application 126 within the client application 107 at the client device 106 in conjunction with the quote guidance process 200 of FIG. 2. In this regard, FIGS. 3-7 are merely illustrative and not intended to be limiting.

FIG. 3 depicts a quote GUI display 300 including a quote configuration region 302 that reflects an initial quote for an order management product having an initial value for the quantity attribute of 100 user licenses and an initial value for the term attribute of 36 months. Using the obtained pricing model associated with the order management user licenses, the price guidance application 128 calculates an expected discount of 13.8% based on the quantity of 100 user licenses, a term length of 36 months, and other factors associated with the customer or client (e.g., the customer tier, associated industry, etc.), and the quoting application 126 provides a graphical representation 310 of the expected discount percentage within the quote configuration region 310 (e.g., tasks 204, 206). Based on the currently user-configured discount of 0%, the current quote configuration is scored as good or above average, and a graphical indication 312 of the above average qualitative state (e.g., a green flag) is provided within the quote configuration region 310 (e.g., tasks 210, 212). In some embodiments, the initial user-configurable discretionary discount may be defaulted to a target discount percentage, which depending on the embodiment could be correlative to or influenced by the expected discount percentage (e.g., the expected discount percentage adjusted to encourage a desired uplift). Additionally, based on the approval rules associated with the order management user licenses, the quoting application 126 determines that the current quote does not require any approvals based on the current discount percentage being less than the expected discount and/or the current qualitative assessment of the quote and provides a graphical indication 314 that no approvals are required (e.g., tasks 214, 216).

The quote GUI display 300 also includes a quote guidance region 304 that includes a listing 320 of the attributes or factors that are most influential to the expected discount (e.g., pre-existing licenses by the customer, the customer tier, the industry sector, etc.) (e.g., task 208). Additionally, in the illustrated embodiment, the quote guidance region 304 provides a listing 330 of potential quote modifications if a higher discount is required to win the deal. In this regard, as described above, the price guidance application 128 may automatically simulate various alternative scenarios by modifying one or more attributes of the quote, calculating or otherwise determining different expected discounts using the pricing model, and providing the quote modifications and resulting discount expectations to the quoting application 126, which, in turn generates the listing 330 of suggested quote modifications within the quote guidance region 304.

Referring to FIGS. 3-7, in exemplary embodiments, the quote configuration region 302 includes a text box or similar GUI element 306 that allows the user to input a desired discount for the quote, along with text boxes or similar GUI elements 307, 308 that allow the user to modify the quantity and term attribute values for the current quote. It should be noted that although the subject matter may be described herein in the context of the user modifying the proposed discount to be applied to the quote, in alternative embodiments, the user may modify the total price or other aspects of the quote price from which the proposed discount may be calculated. Accordingly, the subject matter described herein is not intended to be limited to any particular type of input pricing information that the user provides or otherwise configures for purposes of analyzing the pricing of the quote.

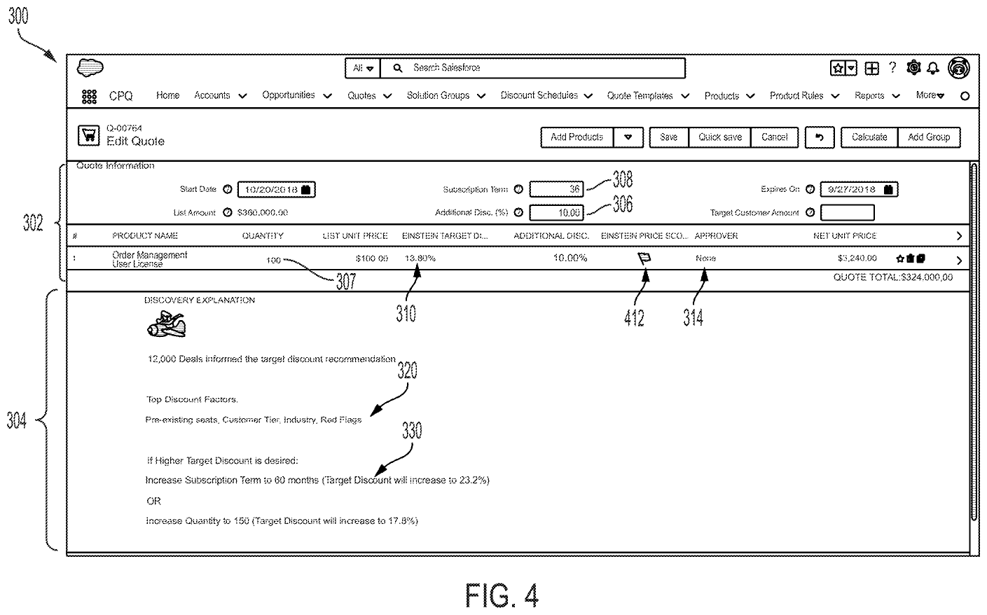

Referring to FIG. 4, in response to modifications to the current discount, the quote guidance process 200 reanalyzes the modified quote to dynamically update the qualitative assessment associated with the quote and reapplies the rules associated with the order management user licenses to the modified quote. Since the current discount is less than the expected discount or otherwise better than a target discount, the updated indication 412 identifies the above average qualitative state (e.g., a green flag).

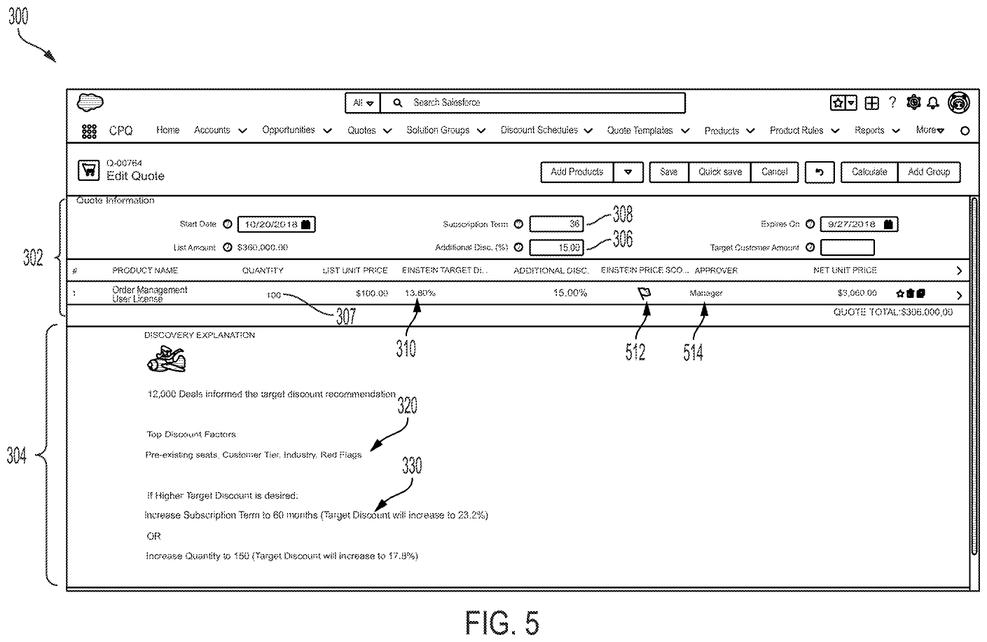

Referring to FIG. 5, a salesperson utilizing the quote GUI display 300 may be negotiating with a potential customer that would like a cheaper unit price or greater discount than the expected discount percentage. To analyze the potential ramifications of increasing the discount, the user of the client device 106 may utilize the text box 306 to increase the discount percentage associated with the quote to 15%. In response to the modified discount attribute, the quote guidance process 200 dynamically updates the qualitative assessment associated with the quote and reapplies the approval rules to the modified quote. In the illustrated embodiment, the price guidance application 128 qualitatively assesses the current quote as average, for example, based on the relative small difference between the current discount percentage and the expected discount percentage, based on the current discount percentage residing between a target discount percentage and a normal or median discount percentage, etc. The updated deal assessment indicia 512 identifies the average qualitative state (e.g., a yellow or orange flag). Additionally, based on the approval rules associated with the order management user licenses, the quoting application 126 determines that the modified quote requires manager approval based on the current discount percentage greater than the expected discount and/or the current qualitative assessment of the quote and provides an updated approval requirement indication 514 that identifies the manager as the required approval level. Based on the deal assessment and approval requirement indicia 512, 514, the salesperson may determine whether to proceed with the current quote or continue with modifying the quote and/or negotiating with the customer.

Referring now to FIG. 6, if the potential customer wants a better price or the salesperson is seeking to shorten the sales cycle, the salesperson may utilize the text box 306 to further increase the discount percentage associated with the quote to 20%. In response to the modified discount, the quote guidance process 200 dynamically updates the assessment associated with the quote and provides updated deal assessment indicia 612 that identify a below average qualitative state (e.g., a red flag). Additionally, based on the approval rules associated with the order management user licenses, an updated approval requirement indication 614 is provided that indicates a vice president is required to approve the quote as currently configured based on the current discount percentage and/or the current quote assessment. Again, based on the deal assessment and approval requirement indicia 612, 614, the salesperson may determine whether to proceed with the current quote or to continue modifying the quote and/or negotiating with the customer.

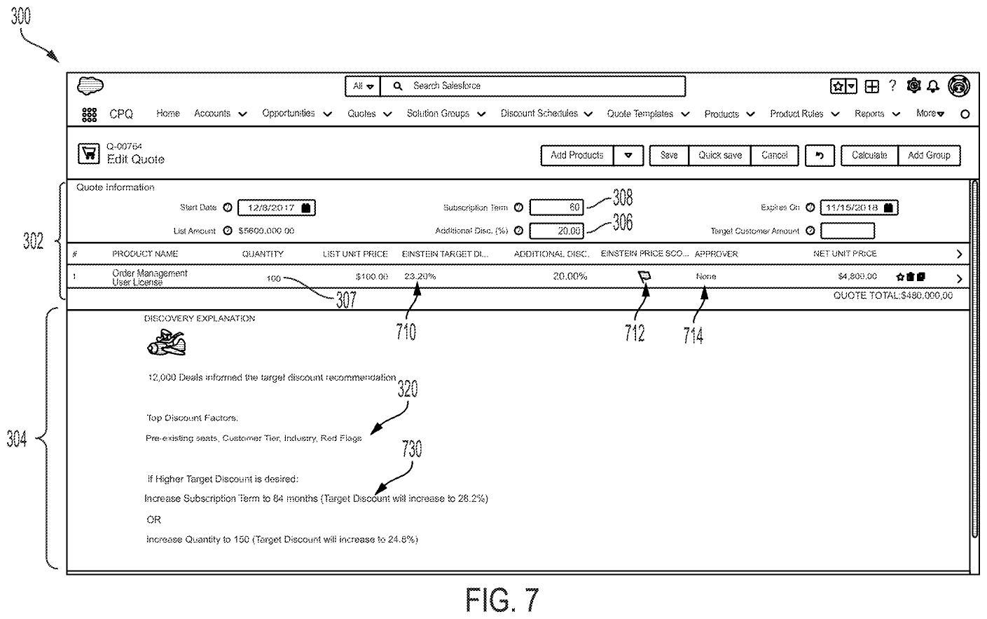

Referring to FIG. 7, if the potential customer requires a pricing for the deal that corresponds to a 20% discount off the list price, the salesperson may utilize the quote guidance region 304 to identify potential modifications to the deal to achieve the desired pricing. Based on the suggested quote modifications 330, the salesperson utilizes the subscription term text box 308 to increase the value for the term attribute associated with the quote. In response to a change to the term attribute value, the quote guidance process 200 dynamically determines expected pricing information using the modified term attribute value and the expected pricing model and arrives at an expected discount percentage of 23.2% based on the current quantity of user licenses and other factors associated with the customer or client, and the quoting application 126 displays a corresponding indication 710 of the expected discount percentage within the quote configuration region 302. The quote guidance process 200 also dynamically updates the assessment of the quote and provides updated deal assessment indicia 712 that identify an above average qualitative state (e.g., a green flag) that reflects the previously-configured discount percentage of 20% is now less than the expected discount percentage and/or less than a target discount percentage based on the modifications to the other quote attributes. An updated approval requirement indication 714 is provided that indicates supervisory approval is no longer required based on the relationship between the current discount and the expected discount for the currently-configured quote. The salesperson may thereby have improved confidence that he or she has priced the quote well and proceed towards closing the deal with reduced concerns over whether to involve supervisors, whether the deal will reflect poorly on the salesperson's performance, or whether the pricing for the quote is likely to otherwise undesirably impact the bottom line. The listing 730 of suggested quote modifications within the quote guidance region 304 may also be dynamically updated to reflect potential modifications to further increase the discounting relative to the recently modified quote.

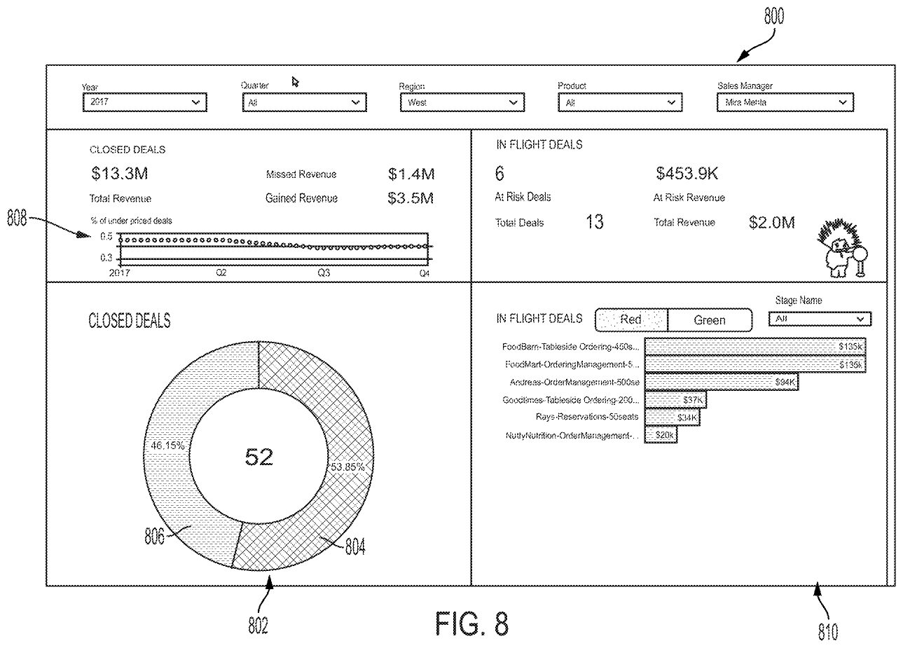

FIG. 8 depicts an exemplary embodiment of a dashboard GUI display 800 that may be presented by the quoting application 126 within the client application 107 at the client device 106. In this regard, the dashboard GUI display 800 may be utilized to summarize the performance of an individual salesperson or a group of salespersons underneath a particular manager or other supervisory user. The dashboard GUI display 800 includes a gauge chart 802 that includes a first portion 804 corresponding to a percentage of closed quotes that were priced at or above the expected pricing and a second portion 806 corresponding to the percentage of closed quotes that were priced below the expected pricing. In this regard, when a quote is generated using the quoting application 126, the corresponding database object 110 for that quote may include one or more fields that identify whether or not the discount percentage associated with the quote was greater than a threshold corresponding to the expected discount percentage calculated for that respective quote based on the historically-derived pricing model (where the model-expected discount may be potentially scaled down or reduced by some amount to encourage uplift). For example, when the quote depicted in any one of FIG. 3-4 or 7 is closed, saved, or exited, one or more fields associated with the corresponding quote database object 110 may be modified by the quoting application 126 to indicate the quote was priced better than expected. Conversely, if the quote depicted in one of FIG. 5 or 6 were completed, one or more fields associated with the corresponding quote database object 110 may be modified by the quoting application 126 to indicate the quote was priced lower than expected.

To generate the gauge chart 802, the quoting application 126 queries the database 104 to identify the relevant quote database objects 110 (e.g., all quotes associated with salespersons working under the supervisory user viewing the dashboard GUI display 800) completed within a specified timeframe, and then analyzes the fields associated with the retrieved quotes to determine the number of well-priced deals, the number of underpriced deals, and generate the corresponding portions 804, 806 of the gauge chart 802. The illustrated dashboard GUI display 800 also includes a trendline graph 808 that reflects the relative distribution of the pricing of completed deals with respect to time. The dashboard GUI display 800 also includes a region 810 that allows for review of in-progress quotes that are yet to be closed or completed, broken down by whether their currently-proposed pricing is above or below the expected pricing.

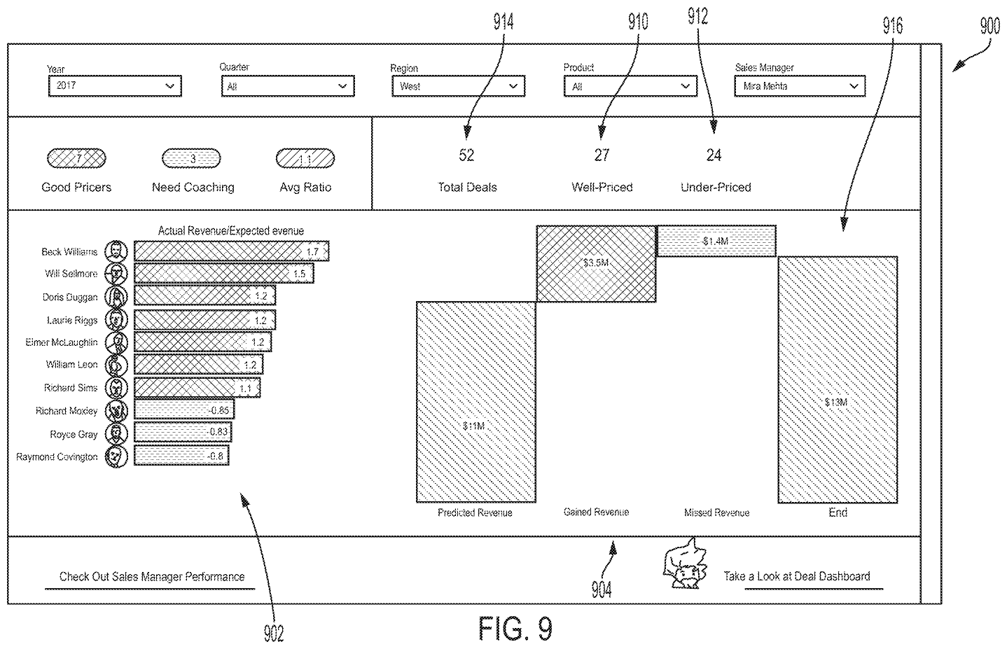

FIG. 9 depicts another embodiment of a dashboard GUI display 900 that may be presented for a manager or other supervisory user of the client device 106. The dashboard GUI display 900 includes a group performance region 902 that includes an ordered listing of salespersons associated with a particular group according to a revenue differential metric determined based on the relationship between the actual pricing for a respective salesperson's closed deals and the expected pricing. In this regard, the difference between the actual discount percentage utilized in a closed quote and the expected discount percentage determined for that quote using the historical pricing model may be utilized to determine a corresponding net increase or decrease in revenue attributable to that quote.

For example, the expected total for the quote depicted in FIG. 7 may be calculated as $460,800 using the expected discount percentage of 23.2%. By virtue of the actual discount percentage being less than the expected discount, the closed total for the quote exceeds the expected total for the quote by $19,200, which represents the net increase in revenue attributable to the salesperson's pricing. When a quote generated using the quoting application 126 is closed, the corresponding database object 110 for that quote may include a field that maintains the net revenue effect of the deal pricing. To generate the listing depicted in the region 902, the quoting application 126 queries the database 104 to identify the quote database objects 110 associated with each respective salesperson in the group, and then accumulates the net revenue amounts for each respective salesperson's closed quotes to obtain a cumulative revenue differential metric associated with the respective salesperson, which, in turn may be utilized to rank, sort, or otherwise order the salesperson's by their cumulative revenue differentials.

The dashboard GUI display 900 also includes a deal breakdown region 904 includes a bar chart having bars 910, 912 depicting the cumulative revenue differentials associated with the respective subsets of quotes categorized as well-priced or underpriced with respect to bars 914, 916 depicting the actual revenue and the projected revenue. In this regard, the length or amount associated with the projected revenue bar 914 represents the cumulative revenue associated with the existing quotes that would be expected based on the historical pricing model, as applied to each respective quote, and the length or amount associated with the actual revenue bar 916 represents the cumulative revenue associated with the existing quotes. The gained revenue bar 910 associated with well-priced deals (e.g., quotes with actual discount percentages less than their respective expected discount percentages or positive net revenue differentials) is adjacent to the projected revenue bar 914 and extends upwards from the top of projected revenue bar 914 by a length or amount corresponding to the cumulative revenue differential calculated based on the subset of well-priced deals. The missed revenue bar 912 associated with underpriced deals (e.g., quotes with actual discount percentages greater than their respective expected discount percentages or negative net revenue differentials) is between the gained revenue bar 910 and the actual revenue bar 916 and extends downwards from the top of gained revenue bar 910 by a length or amount corresponding to the cumulative revenue differential calculated based on the subset of underpriced deals. Thus, the bars 910, 912, 914, 916 in the deal breakdown region 904 allows the supervisory user to assess how the distribution of pricing across deals is impacting the bottom line revenue.

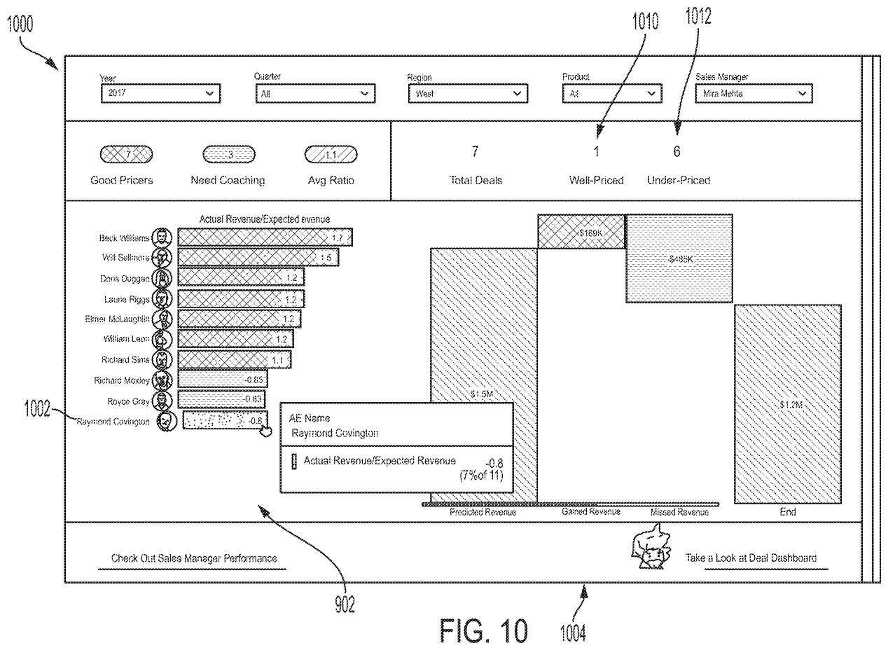

FIG. 10 depicts an exemplary dashboard GUI display 1000 that may be presented in response to selection of a GUI element associated with a salesperson 1002 from within the group performance region 902. In this regard, selection of a salesperson GUI element 1002 within the group performance region 902 triggers the quoting application 126 updating the deal breakdown region 1004 to reflect only those closed quotes associated with the selected salesperson. Thus, for the salesperson-specific deal breakdown region 1004, the gained revenue bar 1010 has a length or amount corresponding to the cumulative revenue differential calculated based solely on the selected salesperson's well-priced deals, while the missed revenue bar 1012 has a length or amount corresponding to the cumulative revenue differential calculated based solely on the selected salesperson's underpriced deals. Based on the lengths of the bars 1010, 1012 and the corresponding number of closed quotes associated with each respective bar 1010, 1012, the supervisory user may better assess the pricing performance associated with the selected salesperson to determine whether or how to coach the salesperson to improve pricing performance. For example, in the illustrated embodiment, the salesperson-specific deal breakdown region 1004 indicates that the selected salesperson disproportionately underprices quotes, and thus, the supervisory user may determine that the selected salesperson may require increased coaching or guidance with respect to pricing, as compared to other scenarios where an individual salesperson may have one or two underpriced outliers that skew his or her performance. In those scenarios, the supervisory user may further review those outlier quotes to assess the individual salesperson's performance with respect to a specific quote.

Thus, by virtue of the subject matter described herein, salespersons can price quotes with greater confidence and a better understanding of the proposed deal with respect to client situation to provide value-matched pricing. Additionally, managers or other supervisors may gain improved insights on the pricing performance of different salespersons and derive a better understanding of how different individuals' pricing which may be leveraged to help improve pricing performance by those individuals. Different approval rules, qualitative and/or quantitative deal assessment threshold, and the like may be employed to further guide quoting and drive pricing behavior, which, in turn, may improve revenue. Additionally, by virtue of the historically-derived pricing models accounting for a wide range of variables, the resulting pricing guidance provided to salesperson is consistent with expectations for a given order size, term length, industry sector, geographic region, customer tier, and/or the like, thereby reducing the likelihood that sales will be lost due to overpricing, while also ensuring pricing matches the client's expected value from the products. Better matching price with customer value creates pricing that is tailored to increase revenue, improve deal win rate, and reduce sales cycles. Leveraging artificial intelligence or machine learning techniques to derive expected pricing models based on historical data also reduces the costs and lead time that could otherwise be incurred by outsourcing pricing guidance to third-party professional services.

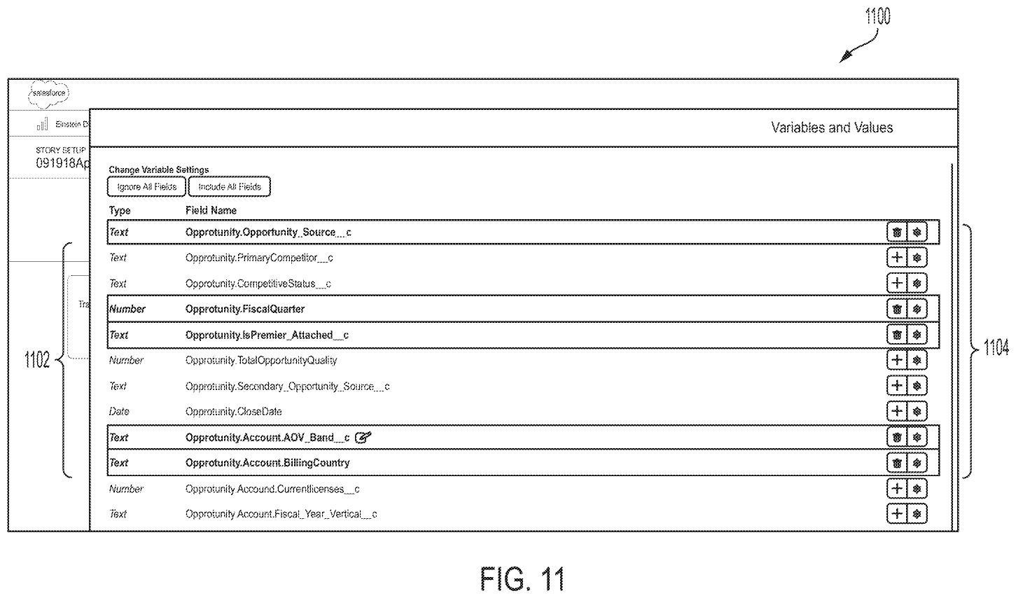

FIG. 11 depicts an exemplary model configuration GUI display 1100 that may be provided by the application platform 124 within a client application 107 on a client device 106 to allow a user to manually configure an expected pricing model 116. For example, by default, the application platform 124, the price guidance application 128, or another component of the server 102 or database 104 may utilize artificial intelligence to analyze attributes of previous quotes maintained in the historical data 118 associated with the user (or the user's organization or group) with respect to an outcome variable (e.g., the final discount percentage, the final per unit price, or the like) to identify a correlative subset of attributes to be utilized as input variables to the model initially. Then, using that subset of variable, regression modeling is run with respect to the historical data 118 to develop a model or set of models for calculating expected pricing (e.g., the expected discount percentage, the expected per unit price, or the like). The model configuration GUI display 1100 may be utilized by a user to add or remove attributes from the potential input variables for the model. In this regard, the model configuration GUI display 1100 includes a listing 1102 of attributes or other fields or parameters that may be associated with a quote that are available for analysis and/or inclusion in the model, along with corresponding GUI elements 1104 that may be utilized by a user to add or remove quote attributes from consideration by or inclusion into the model.

FIG. 11 depicts an example where the source of the opportunity associated with the quote, the fiscal quarter associated with the opportunity, the customer tier associated with the opportunity, the average order value associated with the account associated with the opportunity, and the billing country associated with the account are among the attributes selected for consideration and/or inclusion in the model. After a user modifies the attributes for the model, the application platform 124, the price guidance application 128, or another component of the server 102 or database 104 may reanalyze the historical data 118 to develop a model for calculating the expected pricing using the modified subset of variables.

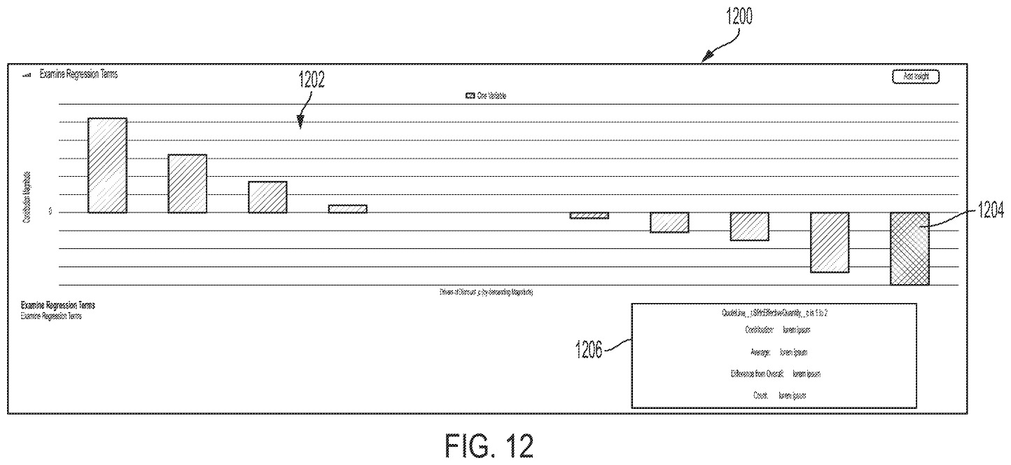

FIG. 12 depicts an exemplary variable analysis GUI display 1200 that may be provided by the application platform 124 within a client application 107 on a client device 106 in connection with a user manually configuring the expected pricing model 116. For example, the user may select a GUI element depicted on another GUI display (e.g., GUI display 1100) to cause the application platform 124 to provide the variable analysis GUI display 1200 that includes a bar chart 1202 or another suitable report that graphically depicts the relative significance and relative weighting of different quote attributes/attribute values with respect to the model. In the illustrated, each bar depicted in the bar chart 1202 corresponds to a respective quote attribute that was analyzed as an input variable as part of the regression modeling. Selection of an individual bar 1204 corresponding to an individual quote attribute results in the application platform 124 generating or otherwise providing a window 1206 that includes detailed information pertaining to the selected quote attribute, such as various quantifications of the manner or degree of correlation between the selected quote attribute and the expected pricing. A user may utilize the variable analysis GUI display 1200 to identify which quote attributes are most influential on expected pricing or to identify which quote attributes should be removed from consideration as model input variables to tailor the expected pricing model in a desired manner. For example, a user may remove a quantity attribute from consideration based on his or her determination that the historical data may be undesirably biased towards quantity-based discounting or to otherwise guide salespersons away from quantity-based discounting practices.

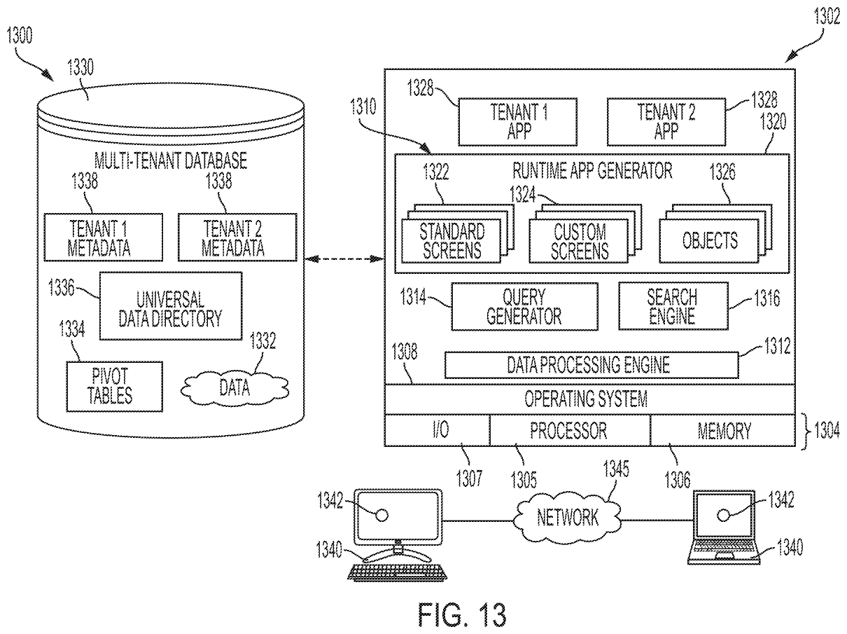

FIG. 13 depicts an exemplary embodiment of an on-demand multi-tenant database system 1300 suitable for use with the quote guidance process 200 of FIG. 2 or the computing system 100 of FIG. 1. The illustrated multi-tenant system 1300 of FIG. 13 includes a server 1302, such as server 102, that dynamically creates and supports virtual applications 1328 based upon data 1332 from a common database 1330 (e.g., database 104) that is shared between multiple tenants, alternatively referred to herein as a multi-tenant database. Data and services generated by the virtual applications 1328 are provided via a network 1345 (e.g., network 108) to any number of client devices 1340 (e.g., client device 106), as desired. Each virtual application 1328 is suitably generated at run-time (or on-demand) using a common application platform 1310 (e.g., application platform 124) that securely provides access to the data 1332 in the database 1330 for each of the various tenants subscribing to the multi-tenant system 1300. In accordance with one non-limiting example, the multi-tenant system 1300 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 1330. In this regard, each tenant includes one or more users associated with, assigned to, or otherwise belonging to that respective tenant. To put it another way, each respective user within the multi-tenant system 1300 is associated with, assigned to, or otherwise belongs to a particular tenant of the plurality of tenants supported by the multi-tenant system 1300. Tenants may represent customers, customer departments, business or legal organizations, and/or any other entities that maintain data for particular sets of users within the multi-tenant system 1300 (i.e., in the multi-tenant database 1330). For example, the application server 1302 may be associated with one or more tenants supported by the multi-tenant system 1300. Although multiple tenants may share access to the server 1302 and the database 1330, the particular data and services provided from the server 1302 to each tenant can be securely isolated from those provided to other tenants (e.g., by restricting other tenants from accessing a particular tenant's data using that tenant's unique organization identifier as a filtering criterion). The multi-tenant architecture therefore allows different sets of users to share functionality and hardware resources without necessarily sharing any of the data 1332 belonging to or otherwise associated with other tenants.

The multi-tenant database 1330 is any sort of repository or other data storage system capable of storing and managing the data 1332 associated with any number of tenants. The database 1330 may be implemented using any type of conventional database server hardware. In various embodiments, the database 1330 shares processing hardware 1304 with the server 1302. In other embodiments, the database 1330 is implemented using separate physical and/or virtual database server hardware that communicates with the server 1302 to perform the various functions described herein. In an exemplary embodiment, the database 1330 includes a database management system or other equivalent software capable of determining an optimal query plan for retrieving and providing a particular subset of the data 1332 to an instance of virtual application 1328 in response to a query initiated or otherwise provided by a virtual application 1328. The multi-tenant database 1330 may alternatively be referred to herein as an on-demand database, in that the multi-tenant database 1330 provides (or is available to provide) data at run-time to on-demand virtual applications 1328 generated by the application platform 1310.

In practice, the data 1332 may be organized and formatted in any manner to support the application platform 1310. In various embodiments, the data 1332 is suitably organized into a relatively small number of large data tables to maintain a semi-amorphous “heap”-type format. The data 1332 can then be organized as needed for a particular virtual application 1328. In various embodiments, conventional data relationships are established using any number of pivot tables 1334 that establish indexing, uniqueness, relationships between entities, and/or other aspects of conventional database organization as desired. Further data manipulation and report formatting is generally performed at run-time using a variety of metadata constructs. Metadata within a universal data directory (UDD) 1336, for example, can be used to describe any number of forms, reports, workflows, user access privileges, business logic and other constructs that are common to multiple tenants. Tenant-specific formatting, functions and other constructs may be maintained as tenant-specific metadata 1338 for each tenant, as desired. Rather than forcing the data 1332 into an inflexible global structure that is common to all tenants and applications, the database 1330 is organized to be relatively amorphous, with the pivot tables 1334 and the metadata 1338 providing additional structure on an as-needed basis. To that end, the application platform 1310 suitably uses the pivot tables 1334 and/or the metadata 1338 to generate “virtual” components of the virtual applications 1328 to logically obtain, process, and present the relatively amorphous data 1332 from the database 1330.

Still referring to FIG. 13, the server 1302 is implemented using one or more actual and/or virtual computing systems that collectively provide the dynamic application platform 1310 for generating the virtual applications 1328. For example, the server 1302 may be implemented using a cluster of actual and/or virtual servers operating in conjunction with each other, typically in association with conventional network communications, cluster management, load balancing and other features as appropriate. The server 1302 operates with any sort of conventional processing hardware 1304, such as a processor 1305, memory 1306, input/output features 1307 and the like. The input/output features 1307 generally represent the interface(s) to networks (e.g., to the network 1345, or any other local area, wide area or other network), mass storage, display devices, data entry devices and/or the like. The processor 1305 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 1306 represents any non-transitory short or long-term storage or other computer-readable media capable of storing programming instructions for execution on the processor 1305, including any sort of random access memory (RAM), read only memory (ROM), flash memory, magnetic or optical mass storage, and/or the like. The computer-executable programming instructions, when read and executed by the server 1302 and/or processor 1305, cause the server 1302 and/or processor 1305 to create, generate, or otherwise facilitate the application platform 1310 and/or virtual applications 1328 and perform one or more additional tasks, operations, functions, and/or processes described herein. It should be noted that the memory 1306 represents one suitable implementation of such computer-readable media, and alternatively or additionally, the server 1302 could receive and cooperate with external computer-readable media that is realized as a portable or mobile component or application platform, e.g., a portable hard drive, a USB flash drive, an optical disc, or the like.

The application platform 1310 is any sort of software application or other data processing engine that generates the virtual applications 1328 that provide data and/or services to the client devices 1340. In a typical embodiment, the application platform 1310 gains access to processing resources, communications interfaces and other features of the processing hardware 1304 using any sort of conventional or proprietary operating system 1308. The virtual applications 1328 are typically generated at run-time in response to input received from the client devices 1340. For the illustrated embodiment, the application platform 1310 includes a bulk data processing engine 1312, a query generator 1314, a search engine 1316 that provides text indexing and other search functionality, and a runtime application generator 1320. Each of these features may be implemented as a separate process or other module, and many equivalent embodiments could include different and/or additional features, components or other modules as desired.

The runtime application generator 1320 dynamically builds and executes the virtual applications 1328 in response to specific requests received from the client devices 1340. The virtual applications 1328 are typically constructed in accordance with the tenant-specific metadata 1338, which describes the particular tables, reports, interfaces and/or other features of the particular application 1328. In various embodiments, each virtual application 1328 generates dynamic web content that can be served to a browser or other client program 1342 associated with its client device 1340, as appropriate.

The runtime application generator 1320 suitably interacts with the query generator 1314 to efficiently obtain multi-tenant data 1332 from the database 1330 as needed in response to input queries initiated or otherwise provided by users of the client devices 1340. In a typical embodiment, the query generator 1314 considers the identity of the user requesting a particular function (along with the user's associated tenant), and then builds and executes queries to the database 1330 using system-wide metadata 1336, tenant specific metadata 1338, pivot tables 1334, and/or any other available resources. The query generator 1314 in this example therefore maintains security of the common database 1330 by ensuring that queries are consistent with access privileges granted to the user and/or tenant that initiated the request. In this manner, the query generator 1314 suitably obtains requested subsets of data 1332 accessible to a user and/or tenant from the database 1330 as needed to populate the tables, reports or other features of the particular virtual application 1328 for that user and/or tenant.

Still referring to FIG. 13, the data processing engine 1312 performs bulk processing operations on the data 1332 such as uploads or downloads, updates, online transaction processing, and/or the like. In many embodiments, less urgent bulk processing of the data 1332 can be scheduled to occur as processing resources become available, thereby giving priority to more urgent data processing by the query generator 1314, the search engine 1316, the virtual applications 1328, etc.

In exemplary embodiments, the application platform 1310 is utilized to create and/or generate data-driven virtual applications 1328 for the tenants that they support. Such virtual applications 1328 may make use of interface features such as custom (or tenant-specific) screens 1324, standard (or universal) screens 1322 or the like. Any number of custom and/or standard objects 1326 may also be available for integration into tenant-developed virtual applications 1328. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. For example, a virtual CRM application may utilize standard objects 1326 such as “account” objects, “opportunity” objects, “contact” objects, or the like. The data 1332 associated with each virtual application 1328 is provided to the database 1330, as appropriate, and stored until it is requested or is otherwise needed, along with the metadata 1338 that describes the particular features (e.g., reports, tables, functions, objects, fields, formulas, code, etc.) of that particular virtual application 1328. For example, a virtual application 1328 may include a number of objects 1326 accessible to a tenant, wherein for each object 1326 accessible to the tenant, information pertaining to its object type along with values for various fields associated with that respective object type are maintained as metadata 1338 in the database 1330. In this regard, the object type defines the structure (e.g., the formatting, functions and other constructs) of each respective object 1326 and the various fields associated therewith.

Still referring to FIG. 13, the data and services provided by the server 1302 can be retrieved using any sort of personal computer, mobile telephone, tablet or other network-enabled client device 1340 on the network 1345. In an exemplary embodiment, the client device 1340 includes a display device, such as a monitor, screen, or another conventional electronic display capable of graphically presenting data and/or information retrieved from the multi-tenant database 1330. Typically, the user operates a conventional browser application or other client program 1342 (e.g., client application 107) executed by the client device 1340 to contact the server 1302 via the network 1345 using a networking protocol, such as the hypertext transport protocol (HTTP) or the like. The user typically authenticates his or her identity to the server 1302 to obtain a session identifier (“SessionlD”) that identifies the user in subsequent communications with the server 1302. When the identified user requests access to a virtual application 1328, the runtime application generator 1320 suitably creates the application at run time based upon the metadata 1338, as appropriate. As noted above, the virtual application 1328 may contain Java, ActiveX, or other content that can be presented using conventional client software running on the client device 1340; other embodiments may simply provide dynamic web or other content that can be presented and viewed by the user, as desired.

Referring again to FIGS. 1-2 with reference to FIG. 13, in one or more exemplary embodiments, the server 1302 and/or the application platform 1310 supports the quote guidance process 200 to provide dynamic GUI updates within client programs 1342 at client devices 1340 in response to changes to quote attribute values within the quoting application 126 provided by the server 1302 and/or the application platform 1310 within the client programs 1342. In this regard, the server 1302 and/or the application platform 1310 queries the database 1330 to obtain the relevant subset of an organization's or tenant's data from the database 104 that is accessible to the user of a client device 1340 (e.g., the quotes, opportunities, or other historical deal data or pricing models associated with the particular organization or tenant) and then updates one or more GUI components or GUI displays presented at the client device 1340 by the client program 1342 to reflect the data obtained from querying the database 1330 as described above.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to querying and other database functions, multi-tenancy, cloud computing, on-demand applications, artificial intelligence, machine learning, and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first,” “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processing systems or devices can carry out the described operations, tasks, and functions by manipulating electrical signals representing data bits at accessible memory locations, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any non-transitory medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like. In this regard, the subject matter described herein can be implemented in the context of any computer-implemented system and/or in connection with two or more separate and distinct computer-implemented systems that cooperate and communicate with one another. In one or more exemplary embodiments, the subject matter described herein is implemented in conjunction with a virtual customer relationship management (CRM) application in a multi-tenant environment.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed is:

1. A method comprising:
obtaining, by a server from a client device coupled to the server over a network, one or more values for one or more attributes of a quote;
obtaining, by the server from a database, a pricing model for the quote, the pricing model being determined based on a relationship between historical values for the one or more attributes and pricing information associated with a plurality of quotes maintained in the database;
determining, by the server, expected pricing information for the quote based on the one or more values for the one or more attributes using the pricing model; and
providing, by the server, a graphical indication of the expected pricing information on the client device.

2. The method of claim 1, further comprising:
identifying a predictive subset of attributes from among a plurality of quote attributes based on a correlation between the predictive subset of attributes of the plurality of quotes maintained in the database and the pricing information associated with the plurality of quotes maintained in the database; and
determining the pricing model as an equation for calculating expected pricing as a function of the predictive subset of attributes based on the relationship between the predictive subset of attributes of the plurality of quotes maintained in the database and the pricing information associated with the plurality of quotes maintained in the database, wherein:
determining the expected pricing information comprises the server calculating the expected pricing information based on the one or more values using the model.

3. The method of claim 1, further comprising:
identifying, by the server, a subset of the attributes of the quote correlative to the expected pricing information; and
providing, by the server, a listing of the subset of the attributes on the client device.

4. The method of claim 1, further comprising:
identifying, by the server, one or more modifications to the one or more values to increase a discount associated with the expected pricing information; and
providing, by the server, a listing of the one or more modifications on the client device.

5. The method of claim 1, further comprising:
obtaining, by the server from the client device, a modification to at least one of the one or more values; and
dynamically updating the expected pricing information in response to the modification.

6. The method of claim 1, further comprising:
obtaining, by the server from the client device, input pricing information associated with the quote;
determining, by the server, an assessment of the quote based on a relationship between the input pricing information and the expected pricing information; and
providing, by the server, a second graphical indication of the assessment on the client device.

7. The method of claim 6, wherein:
obtaining the input pricing information comprises obtaining a proposed discount percentage for the quote;
the expected pricing information comprises an expected discount percentage; and
determining the assessment comprises determining the assessment based on a relationship between the proposed discount percentage and the expected discount percentage.

8. The method of claim 1, further comprising:
obtaining, by the server from the client device, input pricing information associated with the quote;
obtaining, by the server from the database, a rule associated with the quote; and
providing, by the server, one or more graphical indicia on the client device based on application of the rule to the input pricing information.

9. The method of claim 1, further comprising:
obtaining, by the server, input pricing information associated with the quote;
determining, by the server, a revenue differential associated with the quote based at least in part on a relationship between the input pricing information and the expected pricing information; and
providing, by the server, a graphical representation of the revenue differential on the client device.

10. The method of claim 9, wherein providing the graphical representation comprises providing a dashboard graphical user interface (GUI) display depicting the revenue differential.

11. A computer-readable medium having instructions stored thereon that are executable by a processing system of the server perform the method of claim 1.

12. A method comprising:
determining, by a server, an expected pricing model for a product based on a relationship between historical values for one or more attributes of one or more closed quotes associated with the product and historical discount percentages associated with the one or more closed quotes, the historical values and historical discount percentages associated with the one or more closed quotes being maintained in a database coupled to the server;
providing, by the server to a client device coupled to the server over a network, a quote graphical user interface (GUI) display;
receiving, by the server, one or more values for one or more attributes of a quote for the product from the quote GUI display;
calculating, by the server, an expected discount percentage for the quote based on the one or more values using the expected pricing model; and
providing, by the server, a graphical indication of the expected discount percentage on the quote GUI display.

13. The method of claim 12, further comprising:
receiving, by the server, a modification to the one or more values from the quote GUI display;
calculating, by the server, an updated expected discount percentage for the quote based on the modification; and
providing, by the server, a second graphical indication of the updated expected discount percentage in lieu of the graphical indication of the expected discount percentage.

14. The method of claim 12, further comprising:
receiving, by the server, a proposed discount percentage for the quote for the product from the quote GUI display;
obtaining, by the server, an approval rule from the database;
identifying, by the server, an approval requirement for the quote in a manner that is influenced by the proposed discount percentage using the approval rule; and
providing, by the server, a second graphical indication of the approval requirement on the quote GUI display.

15. The method of claim 12, further comprising:
receiving, by the server, a proposed discount percentage for the quote for the product from the quote GUI display;
determining, by the server, an assessment of the quote based on a relationship between the proposed discount percentage and the expected discount percentage; and
providing, by the server, a second graphical indication of the assessment on the quote GUI display.

16. A database system comprising a server coupled to a database and communicatively coupled to a client device over a network to present thereon a graphical user interface (GUI) display comprising a first graphical representation of an expected discount percentage associated with a quote for a product defined using the GUI display and a second graphical representation of an assessment associated with the quote, wherein:
the server calculates the expected discount percentage based at least in part on one or more values for one or more attributes of the quote provided by a user via the GUI display using an expected pricing model obtained from the database;
the expected pricing model is determined based on a relationship between historical values for the one or more attributes of a plurality of closed quotes for the product that are maintained in the database and pricing information associated with the plurality of closed quotes maintained in the database; and
the server determines the assessment based at least in part on a relationship between the expected discount percentage and an input discount percentage provided by the user via the GUI display.

17. The database system of claim 16, wherein the GUI display includes a third graphical representation of a revenue differential calculated for the quote by the server based on a relationship between the input discount percentage and the expected discount percentage.

18. The database system of claim 16, wherein the GUI display includes a third graphical representation of an approval requirement determined for the quote by the server based at least in part on the input discount percentage and an approval rule maintained in the database.

19. The database system of claim 16, wherein:
the GUI display includes a listing of a subset of attributes of the quote correlative to the expected discount percentage; and
the server identifies the subset of attributes based at least in part on the expected pricing model.

20. The database system of claim 16, wherein:
the GUI display includes graphical indicia of one or more modifications to the quote to increase the expected discount percentage;
the server identifies the one or more modifications using the expected pricing model.
